(19) United States
(12) Patent Application Publication
(10) Pub. No.: US 2015/0376873 A1
(43) Pub. Date: Dec. 31, 2015

(54) Water diverter fitting.

(71) Applicant: Christopher Adam McLeod, Toronto (CA)

(72) Inventor: Christopher Adam McLeod, Toronto (CA)

(21) Appl. No.: 14/318,681

(22) Filed: Jun. 29, 2014

(51) Int. Cl. E03B 1/04; E03F 5/04; B01D 35/28

(52) U.S. Cl. CPC E03B 1/042; B01D 35/28; E03F 5/04; E03B 2001/045

(57) ABSTRACT

Reuse of household bathing water for subsurface irrigation of landscaping requires a diverter fitting to enable safe diversion of water away from the bathing area to the subsurface irrigation system. The water diverter fitting described includes an inlet port and two outlet ports, as well as a directional strainer. Orientation of the strainer determines which outlet the majority of the water flows out of, the remainder of the water trickling out of the other port to be used in trap priming and enhancement of line flow. One outlet can also be used as a plug and play access point for a plurality of water regulation technologies including drain closure for a bathing vessel and heat recovery technologies. The directional strainer also serves as a removable fiber filter, and fits within the drain fitting such that a blockage in the water reuse system will allow automatic backflow to the primary sanitary drain without intervention by the bather and without pooling of diverted water. Directing both ports to the primary sanitary drain will result in a higher drainage fitting.

### CROSS-REFERENCE TO RELATED APPLICATIONS

No cross reference is made to other applications.

### STATEMENT REGARDING FEDERALLY SPONSORED RESEARCH OF DEVELOPMENT

No Federal Government support was received in the development of this Invention.

### SEQUENCE LISTING, TABLE, OR COMPUTER PROGRAM LISTING

No sequence listing, table, or computer program is attached or accompanies this Application.

### PATENTOR

Christopher Adam McLeod is the Sole Inventor of this Utility.

### FIELD OF THE INVENTION

This Invention relates generally to bathing area fittings connecting to pipes, and more particularly to water diverter fittings connecting bathing areas to more than one drainage system of pipes.

### BACKGROUND OF THE INVENTION

A diverter fitting refers to a pipe connector that includes the ability to change the direction of some or all of the guided flow of water from one outlet of the fitting to the other. A subsurface irrigation system refers to an assembly of fittings and pipe lain below the surface of landscaping contiguous with a dwelling for the purpose of directing drainage water throughout the landscaping while avoiding contact with animals and said drained water. Fiber refers to hair and other fibrous waste found in bathing area drainage water. A strainer herein refers to a cuplike filter that can be inserted and removed from the interior of the diverter fitting. Strainers originally performed the function of straining of solid from liquid in drainage. In this Invention, the strainer performs an additional function of determining which outlet receives the majority of drainage flow, and is therefore referred to as a directional strainer. The primary sanitary drain refers to that assembly of piping and connectors leading to traditional drains for water, including municipal sewage systems, septic systems, collector tanks, or surface waters. A plug and play outlet refers to an outlet to which a plurality of functional pieces sharing the same coupling dimensions may be separately attached. A three-way valve consists of an inlet for water and two outlets, one of which is selected for and the other selected against using a variety of mechanisms that disallow backflow from one outlet to the other outlet. Priming of a trap refers to the continual refreshment of the water in a plumbing pipe trap to prevent ingress of sewer gases into the building.

The drainage system for a bathing area such as a shower pan, tiled shower area, or bath is supplied beneath the bathing area to allow for gravity fed drainage. A conventional three way valve has hitherto been used to redirect bathing drain water for use as a resource for subsurface irrigation of household landscaping, requiring the conscious selection of the destination for the drainage water, leading to a number of risks that could compromise the integrity of the building. Said risks include failure of the irrigation system leading to slowing or failure in the ability to drain the bathing area with subsequent flooding and structural damage, also the drying out of traps in piping leading to the primary sanitary drain with subsequent infiltration of the dwelling with odiferous and dangerous sewer gases, and poor line flow performance in the primary sanitary drain system arising from the use of low flow toilets, faucets, and shower heads not providing sufficient water to vector solids to the primary sanitary drain both within the household property and as a system overall, exacerbated by freezing and other extreme weather events. Of particular concern to three-way valves is the necessity for the bather to be aware of which outlet is being currently used, often a challenge when the diversion fitting is not in the bathing area. In many diversion-to-irrigation systems the three way valve is also located at a distance from the upstream drainage orifice, leading to a column of water between said orifice and said three way valve that may pose a stagnation, infection, and freezing risks. Fiber removal by the diverter is also critical to avoid fouling of either the irrigation system or the primary sanitary drain, and also must be provided in the bathing area to enable easy and safe diversion.

Said risks indicate that necessity of provision of a safe water diverter fitting that achieves the design objectives of easy fiber removal, easy bather choice of the primary destination of drained water, provision of back flow to the primary sanitary drain in case of performance failure of the secondary water usage system, provision of a constant trickle flow of drained water to the primary sanitary drain for trap priming and line flow maintenance, and avoidance of pooling of diverted water. All of these are issues used by regulators and building inspectors against the installation of subsurface irrigation systems and correspondingly there is a pressing need to eliminate these valid but avoidable problems through design to further support the reuse of drainage water. Accordingly the Invention described in this Application is important for drought affected areas to enable safe drainage water reuse in landscaping and other applications.

### SUMMARY OF THE INVENTION

Accordingly, it is an objection of this invention to at least partially overcome some of the disadvantages of the prior art.

The Invention, a water diversion fitting, as described in this Application is a drainage fitting attaching to and forming the drainage orifice of bathing areas including but not restricted to shower pans, tiled shower areas, and baths. Generally speaking the Invention includes a flanged externally threaded pipe for threading through a drainage surface hole, an internal strainer, an upmost inlet protection device, and the main fitting body equipped with a flanged threaded inlet and two outlets. A plurality of sealing gaskets are also used for leakage control by sealing the surface of upper flange of the main fitting body to the underside of the bathing area surface.

More particularly, in the water diverter fitting in this Application the features forming the drainage inlet are several in function. First, the flanged externally threaded pipe is suspended on the periphery of the drainage hole in whatever surface is available in the bathing area, be it the bottom of a plastic shower pan, a tiled surface, the bottom of a bathing vessel, or other horizontal drainage surface with a slope for drainage to said hole. By threading said flanged externally threaded pipe into an internal thread in the main body of the underlying fitting, sometimes also referred to as a “shoe”, said drainage surface can be sandwiched between the topmost flange and the flange on the upper side of the main body of the fitting. By fitting an annular sealing gasket between the main body upmost flange and the underside of the drainage surface, and subsequent tightening of the threadmate constituted by the external thread on the upper flanged pipe and the internal thread in the inlet of the main body of a the diverter fitting, said drainage surface can be sealed against leakage of water to anywhere other than through the inlet of the underlying drainage fitting. Liberal application of silicon sealant to all contiguous surfaces is usually necessary to finalize leakage control.

Said flanged externally threaded pipe is detailed to support a drainage inlet protection insert in a plurality of designs involving supports between said insert, such as a disc or grid, and the flange of the flanged externally threaded pipe. Said flange of the flanged externally threaded pipe is also provided with an internal step peripheral to the internal diameter of said pipe. Said circular step provides a resting place for the flange of the strainer. Said insert and strainer must be easily manipulated for removal to enable cleaning of the fiber strainer, and to reorientate the strainer. The novel strainer in this Invention is formed such that the majority of the drainage water flow can be redirected to flow outlet one outlet and not the other. This redirection is not a simple three-way valve. If one outlet is called secondary and the other outlet called primary, blockage of the secondary outlet will result in sufficient water flow reversing around the strainer and back out the primary outlet. If the novel strainer is rotated, the reverse functionality can be achieved. In real usage terms, using a three-way valve to divert bathing drainage water to a secondary water use system can give rise to drying out of the primary sanitary drain accessed by the primary outlet. Provision of a variable minor flow to the primary sanitary drain while diverting the majority of the drainage water to the secondary usage system is a necessary feature of a diverter fitting for the building inspector.

Both outlets are cylindrical, of equal diameter, and have their cylindrical axes in the same horizontal plane. While the fitting described in this Application has collinear cylindrical outlet axes, other angles between axes are possible. Owing to these identical outlets, the diverter fitting diverts without risk of pooling of water should either water destination be plugged or clogged, a unique functionality. Either outlet can also be used as a plug and play port for higher level drain functionality, such as connection of a drain closure mechanism, a temperature measurement device, or a heat exchange module. Another derivative application of this diverter fitting is connecting both outlets to the primary sanitary drain, leading to faster drainage of the bathing area as needed in deeper baths.

### BRIEF DESCRIPTION OF THE DRAWINGS

In the drawings, which illustrate embodiments of the invention:

FIG. 1 shows an isometric view of the diverter fitting in isolation;

FIG. 2 is an exploded lateral view of the diverter fitting;

FIG. 3(a) is a top view of the diverter fitting, and, 3(b) is a lateral section view;

FIG. 4(a) is a top view of the diverter fitting, and, 4(b) is a lateral cross section view showing flow control.

FIG. 5(a) is a top view of the diverter fitting, and, 5(b) is a lateral cross section view showing reversed flow;

FIG. 6(a) is a top view of the diverter fitting, and, 6(b) is a lateral cross section view showing flow control with valve attached;

FIG. 7(a) is a top view of the diverter fitting, and 7(b) is a lateral cross section view showing flow control.

FIG. 8 is a lateral view of the diverter with a plug and play dual cable drain closure control attached;

FIG. 9 is an exploded isometric view of the strainer sub-assembly.

FIG. 10(a) is a lateral view of the diverter, and 10(b) is a lateral cross-section of the diverter showing the gap allowing reverse flow upon blockage of selected outlet.

### DETAILED DESCRIPTION OF THE INVENTION

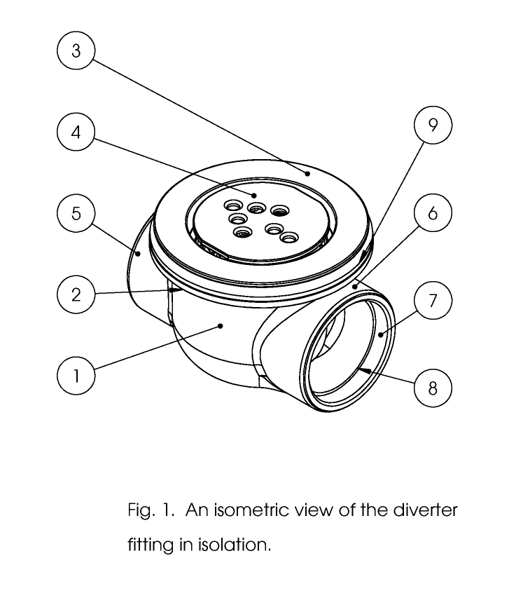

The Invention described in this Application is novel drain fitting for a plurality of water fixtures exemplified by shower pans. The fitting is displayed in isometric view in FIG. 1, wherein a main body 1 supports a top inlet formed by the void between a flange 3 and a central insert 4. Said fitting has a central vertical axis about which two cylindrical outlets 5 and 6 extrude in the horizontal plane, with both horizontal cylindrical outlet axes here represented as collinear, but other angles in the horizontal plane between the two horizontal cylindrical outlet axes are possible. A sealing gasket 9 is included to prevent leakage of water. Each outlet has an internal hub 7 with diameter appropriate for attaching plastic or metal pipe. A pipe stop 8 prevents occlusion of the incoming water by a pipe inserted too far into the fitting.

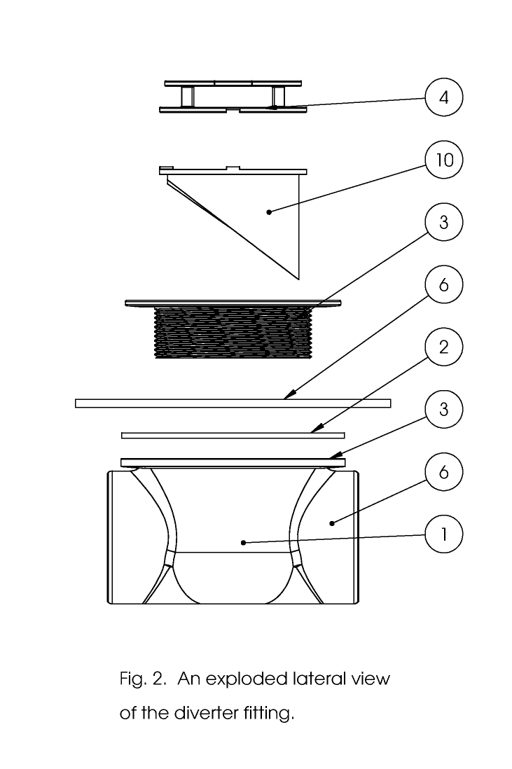

In FIG. 2 an exploded side view of the fitting shows an upmost insert 4 fitting onto a novel strainer 10 that hangs on a flanged thread pipe 3 that threads through the mostly horizontal surface formed by the vessel bottom exemplified by a shower pan 6, then through a sealing gasket 2 to form a waterproof seal against the upper flange 3 of the main body 1 when the flanged threaded pipe 3 is threaded sufficiently tightly into the receiving internal thread of the inlet of the main body 1.

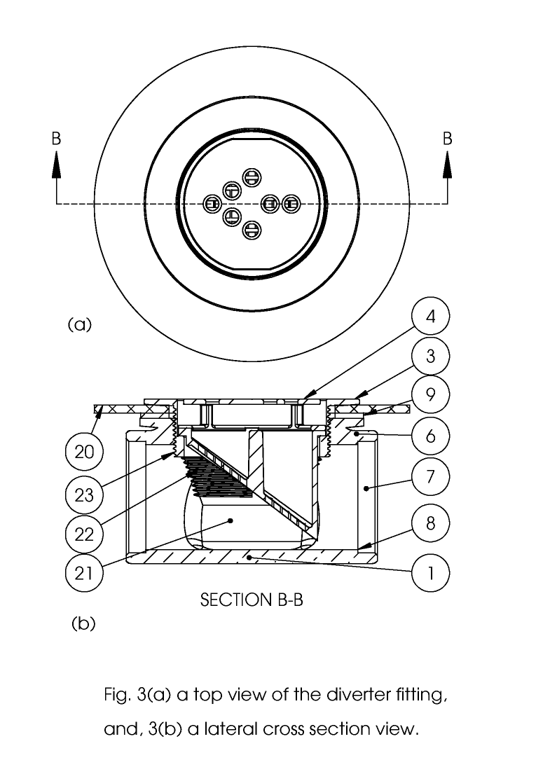

This assembled fitting is shown in FIG. 3(a) a top view and in 3(b) a lateral cross section view. In FIG. 3(b), a lateral cross section of 3(a), the main body of the fitting 1 can be made in a plurality of materials. The upper inlet of main base is machined with an internal thread 22 into which an externally threaded flanged pipe 23 is threaded. The interior of the externally threaded flanged pipe 23 forms a water flow inlet protected by an insert 4. The externally threaded flanged pipe has an external thread and a flange 3. This assembly allows for a sealing gasket 9 to seal against the bottom surface of a vessel bottom 20 exemplified by a shower pan and prevent leakage of water to anywhere else other than the path from inlet to the two outlets. The outlet 6 contains a pipe hub 7 of diameter appropriate to attach a pipe of metal or plastic and a pipe stop 8 to prevent occlusion of water flowing into the fitting interior 21. The remaining outlet 5 is identical in dimension.

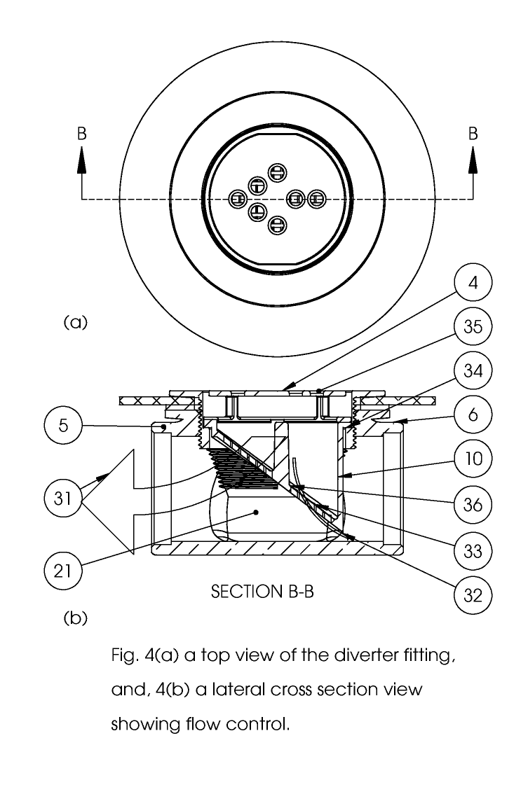

The novel action of this fitting includes the ability to direct water safely to either outlet. In FIG. 4(b), a lateral cross section of FIG. 4(a), water flows in the upper inlet through perforations 35 in the insert 5 and around the periphery of the insert 5 to enter the main chamber 21 of the fitting. Flow control is achieved through the effect of the passing of water through the novel directional strainer 10 comprised of a flanged pipe cut at an oblique angle to the vertical pipe axis. Said cut is filled by a wall 36 perforated by a plurality of perforations 33 arranged in any of a plurality of designs. A secondary purpose of the placement of this strainer amidst the gravity fed flow of water through the upper inlet is to capture fibers that may foul water transmission downstream of the vessel. The primary purpose of the novel strainer 10 is to direct the majority of the drained water to the outlet faced by the oblique perforated wall of the novel directional strainer 10. In FIG. 4 this is outlet 5, and the majority 31 of the water flows out of outlet 5. A smaller flow 32 of water flows out outlet 6 owing to the loose fit of the novel directional strainer 10 into the main cavity 21 of the fitting, allowing for flow under and around the novel directional strainer 10 and out of outlet 6. This trickle flow has a number of essential plumbing functions, including the continual priming and flushing of traps, and allowing for better line flow in a drain system starved of water from low flow toilets and showers, as well as diversion of water to other water usage systems.

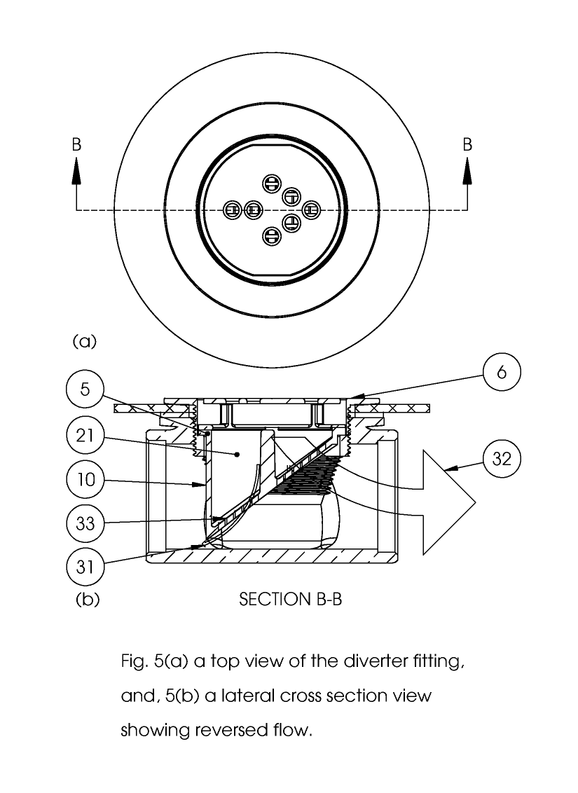

FIG. 5(b) is a lateral cross-section of the top view in 5(a), and shows that by reversing the orientation of the novel directional strainer 10, of water flowing into the main void 21 of the main body of the fitting, the majority 32 of the water flow exits outlet 6, and the minority 33 of the water flow now exits outlet 5.

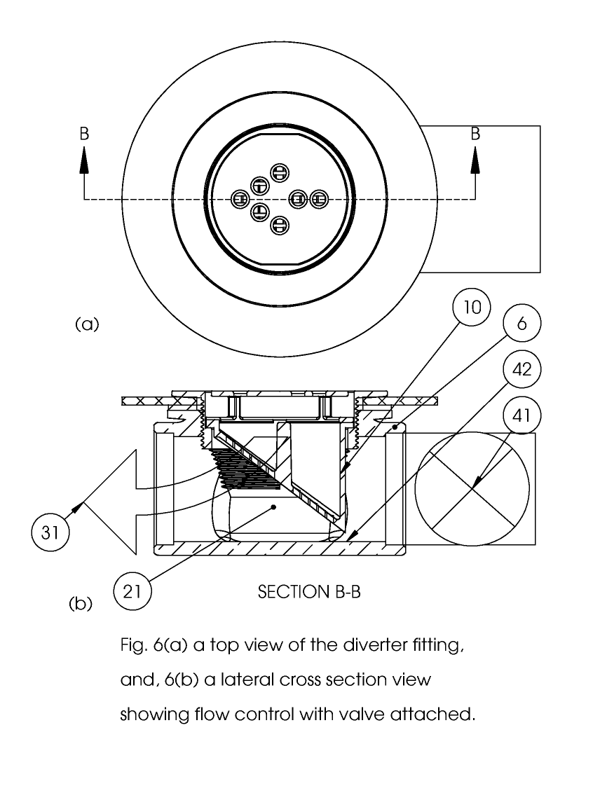

The function of this fitting can be restricted as in FIG. 6(b), a lateral cross section of FIG. 6(a), by fitting of a closeable valve 41 that can be closed to one outlet, here 6. The fitting then becomes a flow elbow with a fiber strainer 10. Note the interior surface wall 42 of the main base 1 is designed to disallow pooling of water.

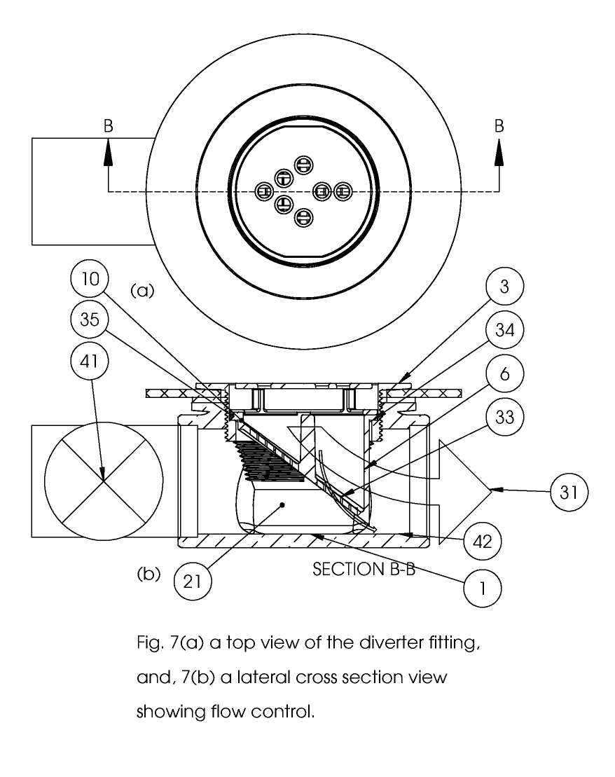

As in FIG. 7(b), a lateral cross section of 7(a), if a closeable valve 41 is moved to the major flow outlet 5 as determined by the orientation of the novel strainer 10, and said valve is closed, then there is sufficient space between the novel strainer 10 and the interior wall surface 42 to redirect the main flow 31 of drain water to the alternate outlet 6. This is a safety device to prevent blockage of drainage out of the internal chamber 21. The valve 41 represents mostly commonly a blockage in the drainage to a secondary drain for reuse of the water, forcing in this valve a redirection of the water to the remaining outlet 6 leading to a primary sanitary drain. This features allows the bather to enjoy normal drainage from the bathing area to the primary sanitary drain, even though the novel directional strainer is orientated such that the majority of the water flow would flow out the outlet 5 were it not blocked. The novel strainer 10 is suspended by its integral flange 34 on an internal step 35 circumferential to the interior wall of the flanged externally threaded pipe 3.

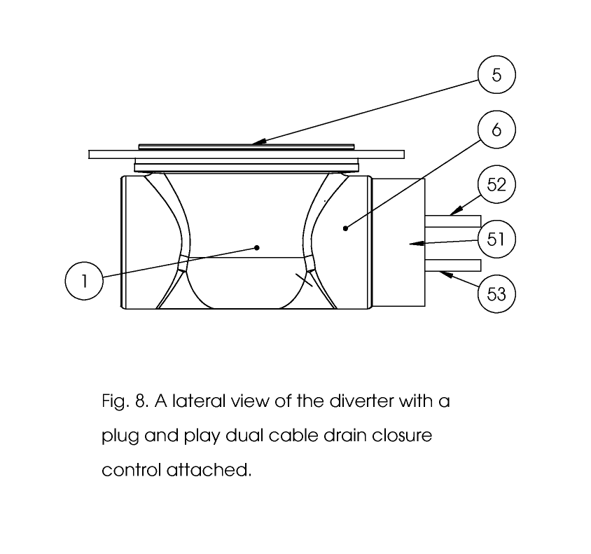

FIG. 8 is a lateral view of the fitting assembly 1 showing a closure control cartridge 51 fitted to the outlet 6. Said control cartridge converts the dual outlet fitting into a drain closure elbow with the addition of a plurality of drain closure mechanisms comprising an upper surface 5 coupled to said control cartridge using one of a plurality of couplings. Connection to control can be mechanical, as in the two cables 52 and 53, or electronic. Similarly, plug and play devices such as a temperature measurement unit or drainwater waste heat recovery unit may be installed in the additional port. Partial or total occlusion of the plug and play port are both possible.

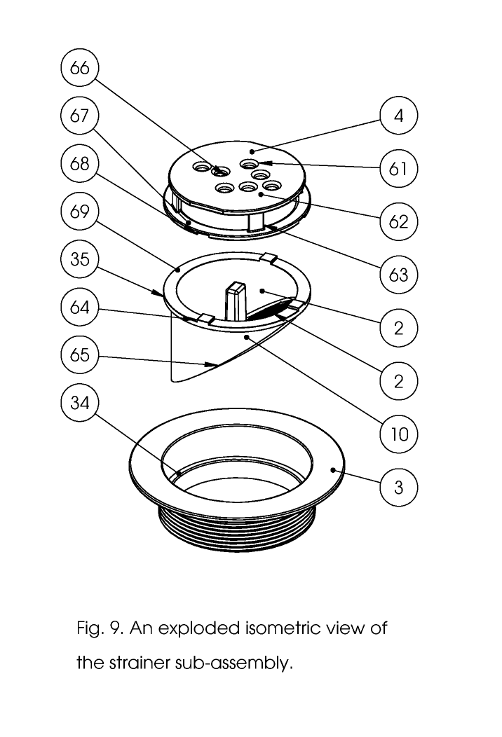

FIG. 9 is an exploded isometric view of the sub-assembly of fitting, illustrating the insert 4 comprising a perforation pattern 61 serving several functions. The first function is to illustrate the direction of the strainer flow directing surface 65. The second function is to provide traction for a shower user. The third function is to aid flow of water into the assembly using the perforations. The main flow of water enters through the void between a lower ring 67 and an upper surface 66 as supported by a plurality of supports 63. A directional pattern of three notches 68 on the underside of the lower ring 47 fits into a complementary pattern of extrusions 64 extruded from the upper surface 69 of the novel strainer 10. Said novel directional strainer is equipped with a flange 35. Upon insertion of the novel directional strainer 10 through the central void of the flanged externally threaded pipe 3, the flange 35 of the novel directional strainer 10 catches on the internal step 34 circumferential to the internal wall of the externally flanged pipe 3.

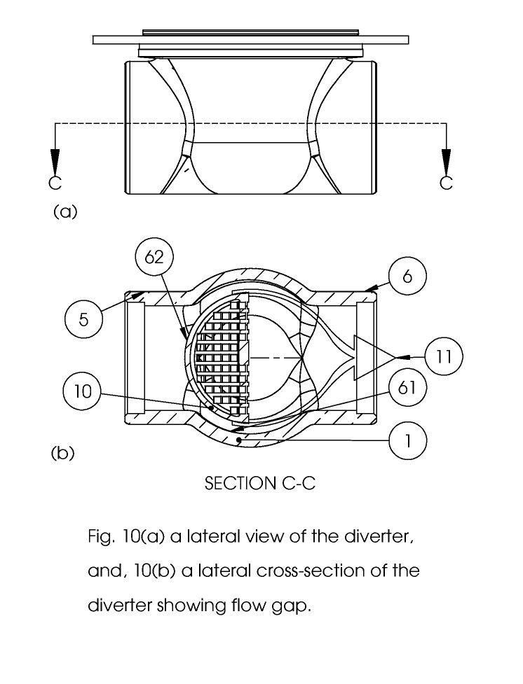

FIG. 10(a) is a lateral view of the fitting assembly cross-sectioned to yield FIG. 10(b) in order to show how the internal surface wall 61 of the main base 1 is spaced far enough from the external diameter 62 of the novel strainer 10 to allow for full flow out of the outlet 6 if outlet 5 is blocked.

The following Claims are made about the Invention described in this Application for use in diverting water drained from a bathing area surface:

1. A water diverter fitting defining a fluid passage comprising:
a main body with an internally threaded, flanged, upper circular inlet and two cylindrical outlets with horizontal cylindrical axes lying in the same horizontal plane below the inlet, said axes being optionally collinear.
a flanged externally threaded pipe threading into the threaded inlet through a bathing surface orifice and annular seal.
a directional strainer inserted into the main body for switching the main flow outlet.
an inlet protector insert.

2. A water diverter fitting as claimed in claim 1 wherein said directional strainer can be used to switch the main flow of drainage water between the two outlets.

3. A water diverter fitting as claimed in claim 1 wherein one of the outlets may be fitted with a plug and play drain closure device.

4. A water diverter fitting as claimed in claim 1 wherein both outlet ports lead to the primary sanitary drain through separate piping enabling an increased rate of drainage flow from the bathing area.
